(19) United States
(12) Patent Application Publication
(10) Pub. No.: US 2021/0152753 A1
(43) Pub. Date: May 20, 2021

(54) Combined Image From Front And Rear Facing Cameras

(71) Applicant: Motorola Mobility LLC, Chicago, IL (US)

(72) Inventor: Xiaofeng Zhu, Nanjing (CN)

(73) Assignee: Motorola Mobility LLC, Chicago, IL (US)

(21) Appl. No.: 16/701,912

(22) Filed: Dec. 3, 2019

(30) Foreign Application Priority Data
Nov. 15, 2019 (CN) 201911120959.8

(51) Int. Cl. H04N 5/272; H04N 5/225; H04N 5/222; H04N 5/262; H04N 5/265

(52) U.S. Cl. CPC H04N 5/272; H04N 5/2258; H04N 5/2628; H04N 5/2621; H04N 5/265; H04N 5/2226

(57) ABSTRACT

In aspects of a combined image from front and rear facing cameras, a dual-camera device has a rear facing camera to capture digital content of a camera scene as viewable with the rear facing camera. The dual-camera device also has a front facing camera to capture a digital image of objects from a viewpoint opposite the rear facing camera. Imagers of the front and rear facing cameras are operational together to capture the digital content and the digital image approximately simultaneously. The dual-camera device implements an imaging manager module that can select an object depicted in the digital image for extraction from the digital image, and then generate a combined image by superimposing the extracted object over the digital content as being captured by the rear facing camera. The combined image of the extracted object superimposed over the digital content can be recorded, displayed, and/or communicated to another device.

### RELATED APPLICATION

This application claims the priority benefit of China Patent Application for Invention Serial No. 201911120959.8 filed Nov. 15, 2019 entitled “Combined Image from Front and Rear Facing Cameras,” the disclosure of which is incorporated by reference herein in its entirety.

### BACKGROUND

Devices such as smart devices, mobile devices (e.g., cellular phones, tablet devices, smartphones), consumer electronics, and the like can be implemented for use in a wide range of environments and for a variety of different applications. Many different types of mobile phones and devices now include dual cameras to capture digital images, with one front facing camera and one rear facing camera. Typically, only one of the dual cameras is active at any particular time and usable to capture digital images. Generally, the lens of the front facing camera is integrated in or around the display screen of a mobile device, and faces a user as he or she holds the device in a position to view the display screen. Users commonly use the front facing camera to take pictures (e.g., digital images) of themselves, such as self-portrait digital images often referred to as “selfies.” These dual-camera devices typically provide a selectable control, such as displayed on a user interface, that a user can select to switch between using the front facing camera or the rear facing camera. Generally, the lens of the rear facing camera is integrated in the back cover or housing of the device, and faces away from the user toward the surrounding environment, as seen from the point-of-view of the user. Users commonly use the rear facing camera to capture digital images of whatever they may see in front of them in the surrounding environment.

### BRIEF DESCRIPTION OF THE DRAWINGS

Implementations of the techniques for a combined image from front and rear facing cameras are described with reference to the following Figures. The same numbers may be used throughout to reference like features and components shown in the Figures:

FIG. 1 illustrates an example of techniques for a combined image from front and rear facing cameras using a dual-camera device in accordance with one or more implementations as described herein.

FIG. 2 illustrates an example device that can be used to implement techniques for a combined image from front and rear facing cameras as described herein.

FIG. 3 illustrates examples of features for a combined image from front and rear facing cameras using a dual-camera device in accordance with one or more implementations as described herein.

FIG. 4 illustrates an example method of a combined image from front and rear facing cameras in accordance with one or more implementations of the techniques described herein.

FIG. 5 illustrates various components of an example device that can used to implement the techniques for a combined image from front and rear facing cameras as described herein.

### DETAILED DESCRIPTION

Implementations of a combined image from front and rear facing cameras are described, and provide techniques implemented by a dual-camera device to superimpose an object extracted from a digital image captured with a front facing camera over digital content captured as a digital photo or digital video content with a rear facing camera to form a combined image. The combined image (e.g., as a digital photo, a video clip, real-time video, etc.) can then be displayed, recorded, and/or communicated to another device. For example, the combined image can be displayed on a display screen of the dual-camera device, which is then viewable by the user of the device. The combined image of the extracted object superimposed over the digital content may also be recorded, such as to memory of the device that maintains the recording for subsequent access. Additionally, the combined image can be communicated to another device. In implementations, the dual-camera device is a mobile phone or smartphone that can establish communication with other communication-enabled devices, and the mobile phone communicates the combined image, or combined images in the form of digital video content, for viewing at other devices that receive the combined image as a video chat or in another form of communication format of digital content.

In the described techniques, the digital content can be captured as a digital photo or digital video content of the camera scene as viewable with the rear facing camera, such as a digital photo of an environment as viewable with the rear facing camera. The digital image is captured with the front facing camera from a viewpoint opposite of the rear facing camera, and the digital image includes depictions of one or more objects, to include a self-image of the user of the device. Notably, the rear facing camera and the front facing camera of the dual-camera device are operational together to capture the digital content and the digital image approximately simultaneously, and the user of the device does not have to switch between cameras or turn the device around to capture images or video of the surrounding environment. This provides that the user of the dual-camera device can both video chat with a person who has another device, and show the other person the environment that the user sees from the point-of-view of the user holding the dual-camera device. The person with the other device can then see both the user of the dual-camera device in a video chat format, and also see the surrounding environment from the user's perspective.

In aspects of a combined image from front and rear facing cameras, as described herein, the dual-camera device implements an imaging manager module that is designed to select an object from the one or more objects depicted in the digital image. The imaging manager module can utilize any type of selection criteria to determine which object to select in a digital image, such as based on face detection to select a self-image of the user, or based on object characteristics, such as the object that appears the largest of the objects in the digital image, or the object nearest the center of the digital image. Alternatively or in addition, a user of the dual-camera device may provide a selection input, such as in a user interface displayed on the display screen of the device, and the imaging manager module can receive the user selection input that identifies the selected object. The imaging manager module can then extract the selected object from the digital image, such as a digital image that is captured as a self-image of the user with the front facing camera, and the extracted object from the digital image is a depiction of the user.

The imaging manager module that is implemented by the dual-camera device can then generate the combined image by superimposing the extracted object over the digital content as being captured by the rear facing camera of the device. For digital content captured as a digital photo of an environment as viewable with the rear facing camera, the combined image can be generated by superimposing the depiction of the user over the digital photo of the environment. In implementations, the extracted object may be resized to appear proportional in scale as superimposed over the digital content that is captured by the rear facing camera. For example, the imaging manager module can receive a user input to move or resize the depiction of the user that is superimposed over the digital content, as captured by the rear facing camera. As noted above, the combined image (e.g., as a digital photo, a video clip, real-time video, etc.) can then be displayed on a display screen of the dual-camera device, recorded to memory, and/or communicated to another device for viewing, such as in a video chat application.

While features and concepts of a combined image from front and rear facing cameras can be implemented in any number of different devices, systems, environments, and/or configurations, implementations of a combined image from front and rear facing cameras are described in the context of the following example devices, systems, and methods.

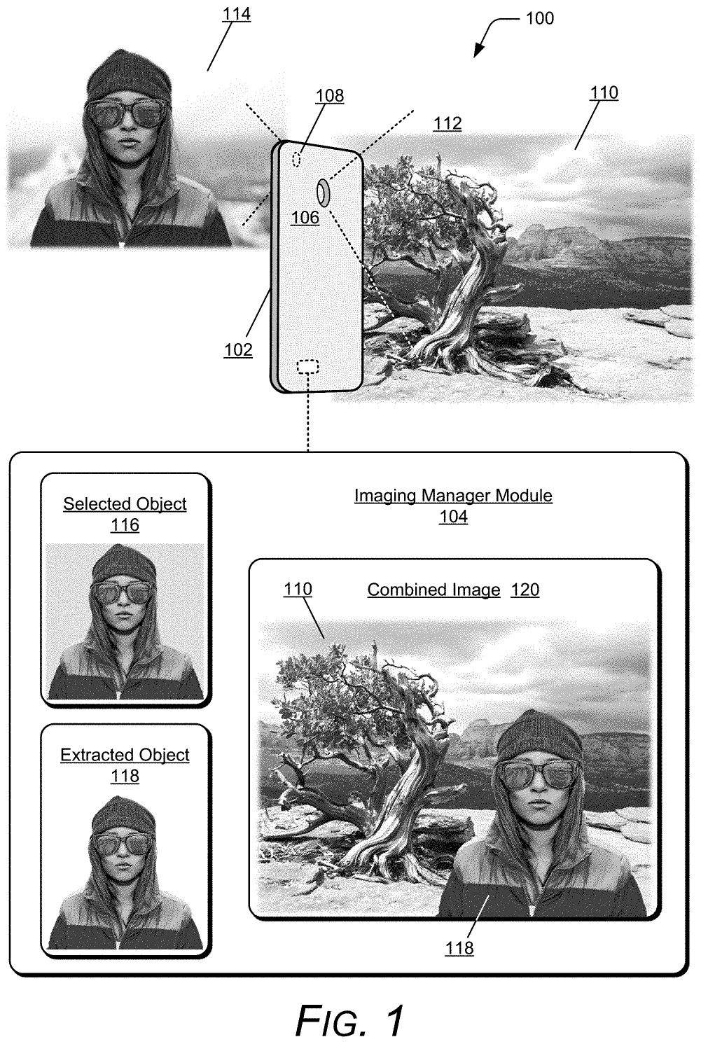

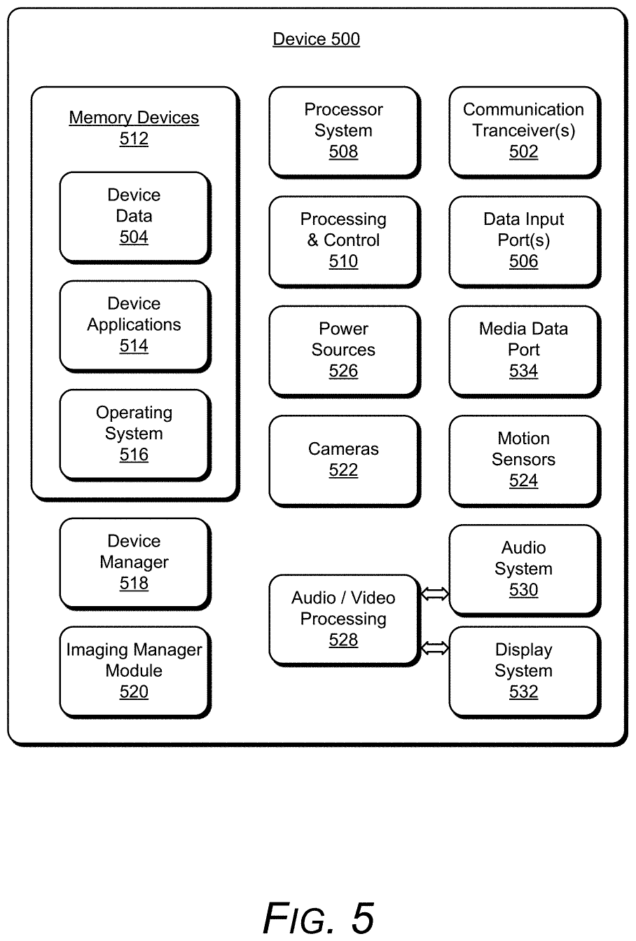

FIG. 1 illustrates an example 100 of techniques for a combined image from front and rear facing cameras using a dual-camera device 102 that implements an imaging manager module 104 to generate the combined image. In this example 100, the dual-camera device 102 may be any type of a mobile device, computing device, tablet device, mobile phone, flip phone, and/or any other type of dual-camera device. Generally, the dual-camera device 102 may be any type of an electronic and/or computing device implemented with various components, such as a processor system and memory, as well as any number and combination of different components as further described with reference to the example device shown in FIG. 5.

In this example 100, the dual-camera device 102 has a rear facing camera 106 and a front facing camera 108. Generally, the rear facing camera 106 includes a lens that is integrated in the back cover or housing of the device, and faces away from a user of the device toward the surrounding environment. The rear facing camera 106 also has an imaging sensor, referred to as an imager, that receives light directed through the camera lens, which is then captured as digital content 110, such as a digital photo or digital video content. For example, the digital content 110 that is captured by the rear facing camera 106 may be a digital photo of an environment as viewable with the rear facing camera. The rear facing camera 106 has a field-of-view (FOV) of the camera, referred to herein as the camera scene 112. As used herein, the term “digital content” includes any type of digital image, digital photograph, a digital video frame of a video clip, digital video, and any other type of digital content.

Similarly, the front facing camera 108 of the dual-camera device 102 includes a lens that is integrated in or around a display screen of the device, and the front facing camera 108 faces the user of the device as he or she holds the device in a position to view the display screen. The front facing camera 108 also has an imager that receives light directed through the camera lens, which is then captured as a digital image 114 from a viewpoint opposite the rear facing camera. Users commonly use the front facing camera 108 to take pictures (e.g., digital images) of themselves, such as self-portrait digital images often referred to as “selfies.” For example, the digital image 114 may be captured as a self-image with the front facing camera 108 from a viewpoint facing the user of the dual-camera device. Generally, the digital image 114 may include depictions of one or more objects, to include an image of the user of the device and/or objects viewable within the field-of-view of the front facing camera 108.

In implementations of a combined image from front and rear facing cameras, as described herein, the imagers of the rear facing camera 106 and the front facing camera 108 are operational together to capture the digital content 110 and the digital image 114 approximately simultaneously. The dual-camera device 102 includes the imaging manager module 104, which may be implemented as a module that includes independent processing, memory, and/or logic components functioning as a computing and/or electronic device integrated with the dual-camera device 102. Alternatively or in addition, the imaging manager module 104 can be implemented as a software application or software module, such as integrated with an operating system and as computer-executable software instructions that are executable with a processor of the dual-camera device 102. As a software application or module, the imaging manager module 104 can be stored in memory of the device, or in any other suitable memory device or electronic data storage implemented with the imaging manager module. Alternatively or in addition, the imaging manager module 104 may be implemented in firmware and/or at least partially in computer hardware. For example, at least part of the imaging manager module 104 may be executable by a computer processor, and/or at least part of the imaging manager module may be implemented in logic circuitry.

The imaging manager module 104 can select an object from any of the objects that may be depicted in the digital image 114 for extraction from the digital image. For example, the selected object 116 may be selected by the imaging manager module 104 as a depiction of the user of the dual-camera device 102. The imaging manager module 104 may utilize any type of selection criteria to determine which object to select in a digital image, such as the object that appears the largest of the objects in the digital image, the object nearest the center of the digital image, the object that has the greatest percentage of the field-of-view of the camera, the object that appears in a focus region of the captured digital image, and/or other types of selection criteria. Alternatively or in addition, a user of the dual-camera device 102 may provide a selection input, such as in a user interface displayed on the display screen of the device, and the imaging manager module 104 can select the object for extraction from the digital image based on receiving the user selection input that identifies the selected object 116.

The imaging manager module 104 is implemented to extract the selected object 116 that is depicted in the digital image 114 as an extracted object 118. In this example 100, the extracted object 118 from the digital image 114 is a depiction of the user of the dual-camera device 102 who has captured the digital image as a self-image with the front facing camera 108 from a viewpoint facing the user of the device. The imaging manager module 104 can then generate a combined image 120, such as by superimposing the extracted object 118 over the digital content 110 as being captured by the rear facing camera 106 of the dual-camera device 102. In this example 100, the combined image 120 is generated by the imaging manager module 104 superimposing the depiction of the user over a digital photo of the environment (e.g., the digital content 110).

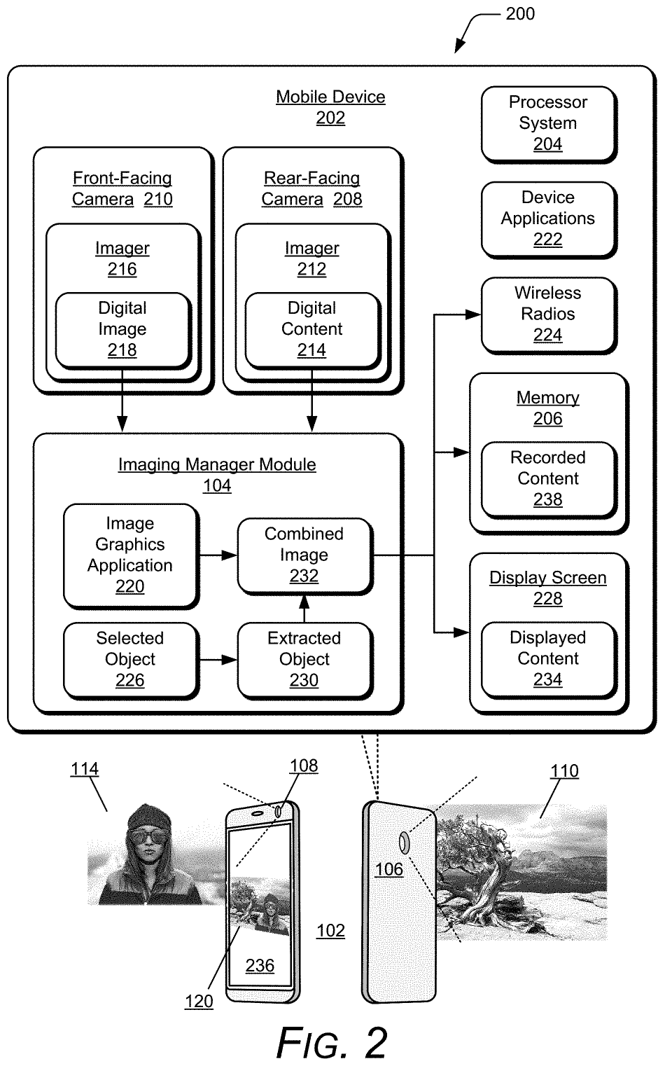

In implementations, the imaging manager module 104 may include, implement, or interface with an image graphics application that is designed for digital image and/or digital video editing, as further described with reference to FIG. 2. The dual-camera device 102 may also include any form of video graphics processor that can be utilized in conjunction with an image graphics application and/or the imaging manager module 104. The image graphics application can be utilized by the imaging manager module 104 to extract the selected object 116 that is depicted in the digital image 114 as the extracted object 118, as well as superimpose the extracted object over the digital content 110 that is being captured by the rear facing camera 106 to generate the combined image 120. Although referred to as an image, the combined image 120 may be a video clip or a digital video that is generated in real-time with the superimposed extracted object 118, which may then be communicated as a video chat or in another communication format to another device, rather than just a still image or digital photo with the extracted object superimposed on the digital content.

In aspects of the described combined image from front and rear facing cameras, the combined image 120 may be displayed, recorded, and/or communicated to another device. For example, the combined image 120 (e.g., as a digital photo, a video clip, real-time video, etc.) can be displayed on a display screen of the dual-camera device 102, which is then viewable by the user of the device as the extracted object 118 superimposed over the digital content. The combined image 120 of the extracted object 118 superimposed over the digital content 110 may also be recorded, such as to memory of the device that maintains the recording for subsequent access, or communicated for cloud-based storage. Additionally, the combined image 120 can be communicated to another device. In implementations, the dual-camera device 102 is a mobile phone or smartphone that can establish communication with other communication-enabled devices, and the mobile phone communicates the combined image 120, or combined images in the form of digital video content, for viewing at other devices that receive the combined image as a video chat or in another form of communication format of digital content.

FIG. 2 illustrates an example 200 of a mobile device 202 that can be used to implement the techniques of a combined image from front and rear facing cameras, as described herein, such as the dual-camera device 102 that is shown and described with reference to FIG. 1. In this example 200, the mobile device 202 may be any type of a computing device, tablet device, mobile phone, flip phone, and/or any other type of mobile device. Generally, the mobile device 202 may be any type of an electronic and/or computing device implemented with various components, such as a processor system 204, to include an integrated or independent video graphics processor, and memory 206, as well as any number and combination of different components as further described with reference to the example device shown in FIG. 5. For example, the mobile device 202 can include a power source to power the device, such as a rechargeable battery and/or any other type of active or passive power source that may be implemented in an electronic and/or computing device.

In implementations, the mobile device 202 may be a mobile phone (also commonly referred to as a “smartphone”) implemented as a dual-camera device. The mobile device 202 includes a rear facing camera 208 and a front facing camera 210. Although the devices are generally described herein as dual-camera devices having two cameras, any one or more of the devices may include more than two cameras. For example, an implementation of the rear facing camera 208 may include two or three individual cameras itself, such as to capture digital content at different focal lengths and/or different apertures approximately simultaneously.

In this example 200, the rear facing camera 208 includes an imager 212 to capture digital content 214, such as a digital photo or digital video content. For example, the digital content 214 that is captured by the rear facing camera 208 may be a digital photo of an environment as viewable with the rear facing camera (also referred to herein as the camera scene). The digital content 110 that is captured with the rear facing camera 106 of the dual-camera device 102 is an example of the digital content 214 that may be captured by the rear facing camera 208 of the mobile device 202.

Similarly, the front facing camera 210 includes an imager 216 to capture a digital image 218 from a viewpoint opposite the rear facing camera. Generally, the digital image 218 may include depictions of one or more objects, to include an image of a user of the device and/or objects viewable within the field-of-view of the front facing camera. The digital image 114 that is captured with the front facing camera 108 of the dual-camera device 102 as a self-image from the viewpoint of the user holing the device and facing the camera is an example of the digital image 218 that may be captured by the front facing camera 210 of the mobile device 202. As noted above and in the described implementations of a combined image from front and rear facing cameras, the imager 212 of the rear facing camera 208 and the imager 216 of the front facing camera 210 are operational together to capture the digital content 214 and the digital image 218 approximately simultaneously.

In this example 200, the mobile device 202 includes the imaging manager module 104 that implements features of a combined image from front and rear facing cameras, as described herein and generally as shown and described with reference to FIG. 1. The imaging manager module 104 may be implemented as a module that includes independent processing, memory, and/or logic components functioning as a computing and/or electronic device integrated with the mobile device 202. Alternatively or in addition, the imaging manager module 104 can be implemented as a software application or software module, such as integrated with an operating system and as computer-executable software instructions that are executable with a processor (e.g., with the processor system 204) of the mobile device 202. As a software application or module, the imaging manager module 104 can be stored on computer-readable storage memory (e.g., the memory 206 of the device), or in any other suitable memory device or electronic data storage implemented with the imaging manager module. Alternatively or in addition, the imaging manager module 104 may be implemented in firmware and/or at least partially in computer hardware. For example, at least part of the imaging manager module 104 may be executable by a computer processor, and/or at least part of the imaging manager module may be implemented in logic circuitry.

Additionally, the imaging manager module 104 may include, implement, or interface with an image graphics application 220 that is designed for digital image and/or digital video editing. In implementations, the image graphics application 220 may be implemented as a software component or module of the imaging manager module 104 (as shown), or alternatively, as an independent device application 222 that interfaces with the imaging manager module 104 and/or an operating system of the device. Generally, the mobile device 202 includes the device applications 222, such as any type of user and/or device applications that are executable on the device. For example, the device applications 222 can include a video chat application that a user of the mobile device 202 may initiate to communicate via video chat with a user of another device that is in communication with the mobile device.

In implementations, the mobile device 202 can communicate with other devices via a network (e.g., LTE, WLAN, etc.) or via a direct peer-to-peer connection (e.g., Wi-Fi Direct, Bluetooth™, Bluetooth LE (BLE), RFID, NFC, etc.). The mobile device 202 can include wireless radios 224 that facilitate wireless communications, as well as communication interfaces that facilitate network communications. The mobile device 202 can be implemented for data communication between devices and network systems, which may include wired and/or wireless networks implemented using any type of network topology and/or communication protocol, to include IP based networks, and/or the Internet, as well as networks that are managed by mobile network operators, such as a communication service providers, mobile phone providers, and/or Internet service providers.

In implementations of a combined image from front and rear facing cameras, the imaging manager module 104 can select an object from any of the objects that may be depicted in the digital image 218 for extraction from the digital image. For example, the selected object 226 may be selected by the imaging manager module 104 as a depiction of the user of the mobile device 202. The imaging manager module 104 may utilize any type of selection criteria to determine which object to select in a digital image 218, such as the object that appears the largest of the objects in the digital image, the object nearest the center of the digital image, the object that has the greatest percentage of the field-of-view of the camera, the object that appears in a focus region of the captured digital image, and/or other types of selection criteria. Alternatively or in addition, the image graphics application 220 may be implemented for facial detection in a digital image to identify and select a face of the user who has captured the digital image 218 as a self-image with the front facing camera 210. Alternatively, a user of the mobile device 202 may provide a selection input, such as in a user interface displayed on a display screen 228 of the device, and the imaging manager module 104 can select the object for extraction from the digital image based on receiving the user selection input that identifies the selected object 226.

The imaging manager module 104 is implemented to extract the selected object 226 that is depicted in the digital image 218 as an extracted object 230. As shown in FIG. 1, the extracted object 118 from the digital image 114 as a depiction of the user of the dual-camera device 102 who has captured a self-image is an example of the extracted object 230. The imaging manager module 104 can then generate a combined image 232, such as by superimposing the extracted object 230 over the digital content 214 as being captured by the rear facing camera 208 of the mobile device 202. In the example shown and described with reference to FIG. 1, the combined image 120 is generated by the imaging manager module 104 superimposing the depiction of the user from the digital image 114 over a digital photo of the environment (e.g., the digital content 110).

In implementations, the imaging manager module 104 can utilize the image graphics application 220 to extract the selected object 226 that is depicted in the digital image 218 as the extracted object 230, as well as superimpose the extracted object over the digital content 214 that is being captured by the rear facing camera 208 to generate the combined image 232 Although referred to as an image, the combined image 232 may be a video clip or a digital video that is generated in real-time with the superimposed extracted object 230, which may then be communicated as a video chat or in another communication format to another device, rather than just a still image or digital photo with the extracted object superimposed on the digital content. Additionally, the combined image 232 may be communicated to another device as a video chat in real-time, or as recorded digital content in another communication format. In implementations, the still image of the extracted object 230 that is superimposed over the digital content 214 to generate the combined image 232 may be updated periodically, such as based on a duration of time having expired, or based on the user of the device capturing another self-image that updates and replaces the digital image 218.

In aspects of the described combined image from front and rear facing cameras, the combined image 232 may be displayed, recorded, and/or communicated to another device. For example, the combined image 232 (e.g., as a digital photo, a video clip, real-time video, etc.) can be rendered for viewing as the displayed content 234 on the display screen 228 of the mobile device 202, which is then viewable by the user of the device as the extracted object 230 superimposed over the digital content. In another example, the combined image 120 generated from the depiction of the user in the digital image 114 superimposed over the digital photo of the environment (e.g., the digital content 110) is shown as displayed content on the display screen 236 of the dual-camera device 102.

The combined image 232 of the extracted object 230 superimposed over the digital content 214 may also be recorded, such as to the memory 206 of the mobile device 202 that maintains the recorded content 238 (e.g., recorded digital content) for subsequent access, and/or for communication for cloud-based storage. Additionally, the combined image 232 can be communicated to another device via the wireless radios 224. In implementations, the mobile device 202 can establish communication with other communication-enabled devices, and the mobile device communicates the combined image 232, or combined images in the form of digital video content as a video chat, for viewing at other devices that receive the combined image as the video chat or in another form of communication format of digital content.

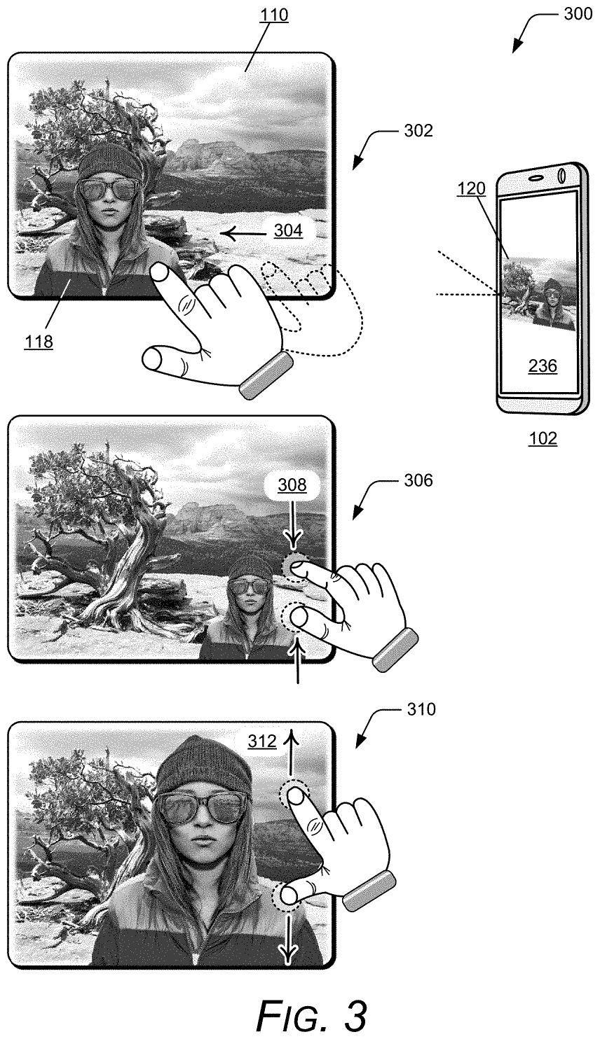

FIG. 3 illustrates examples 300 of features of techniques for a combined image from front and rear facing cameras using a dual-camera device, as described herein. As noted above, the combined image 120 that is generated by the imaging manager module 104 as the depiction of the user in the digital image 114 superimposed over the digital photo of the environment (e.g., the digital content 110) is shown as displayed content on the display screen 236 of the dual-camera device 102. In implementations, a user may then interact with the display of the combined image 120 via the user interface on the display screen to control or change the appearance of how the extracted object 118 that is superimposed over the digital content 110 appears.

For example, as shown at 302, the imaging manager module 104 can receive a user input 304 to move the depiction of the user (e.g., the extracted object 118) that is superimposed over the digital content 110 as being captured by the rear facing camera 106 of the dual-camera device 102. Notably, the extracted object 118 may be moved in any direction and positioned over the digital content 110 at any location. Similarly, the imaging manager module 104 can receive a user input to resize the depiction of the user that is superimposed over the digital content, such as resized to appear proportional in scale over the digital content that is captured by the rear facing camera. For example, as shown at 306, the imaging manager module 104 can receive a user input 308 (e.g., as a pinch, zoom-in input) to resize the self-image of the user that is superimposed over the digital content. Similarly, as shown at 310, the imaging manager module 104 can receive a user input 312 (e.g., as a pinch, zoom-out input) to resize the self-image of the user that is superimposed over the digital content.

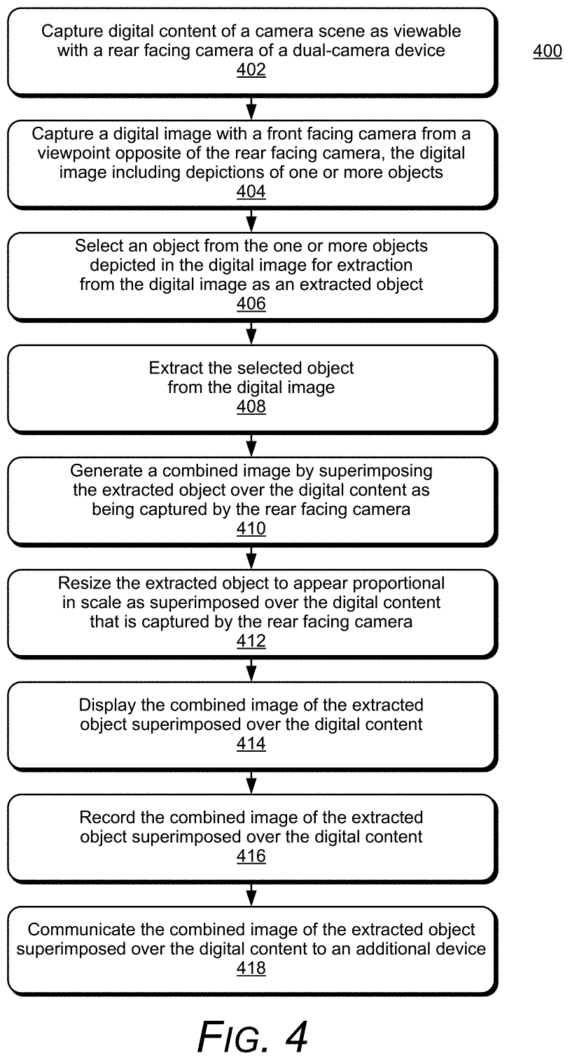

Example method 400 is described with reference to FIG. 4 in accordance with implementations of a combined image from front and rear facing cameras. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 4 illustrates example method(s) 400 of a combined image from front and rear facing cameras, and is generally described with reference to a dual-camera device and an imaging manager module implemented by the device. The order in which the method is described is not intended to be construed as a limitation, and any number or combination of the described method operations can be performed in any order to perform a method, or an alternate method.

At 402, digital content of a camera scene is captured as viewable with a rear facing camera of a dual-camera device. For example, the rear facing camera 106 of the dual-camera device 102 captures the digital content 110 as a digital photo or digital video content of the camera scene 112 as viewable with the rear facing camera. The digital content 110 that is captured by the rear facing camera 106 can be a digital photo of an environment as viewable with the rear facing camera.

At 404, a digital image is captured with a front facing camera from a viewpoint opposite of the rear facing camera, the digital image including depictions of one or more objects. For example, the front facing camera 108 of the dual-camera device 102 captures the digital image 114 that includes depictions of one or more objects (e.g., the self-image of the user of the device). The digital image 114 may be captured as a self-image with the front facing camera 108 from a viewpoint facing a user of the dual-camera device. For example, the front facing camera 108 faces the user of the device as he or she holds the device in a position to view the display screen, and the user can capture a self-image (e.g., a self-portrait digital image). Notably, the rear facing camera 106 and the front facing camera 108 of the dual-camera device 102 are operational together to capture the digital content 110 and the digital image 114 approximately simultaneously.

At 406, an object is selected from the one or more objects depicted in the digital image for extraction from the digital image as an extracted object. For example, the imaging manager module 104 implemented by the dual-camera device 102 can select the object 116 depicted in the digital image 114 for extraction from the digital image as the extracted object 118. The imaging manager module 104 may utilize any type of selection criteria to determine which object to select in a digital image, such as the object that appears the largest of the objects in the digital image, the object nearest the center of the digital image, the object that has the greatest percentage of the field-of-view of the camera, the object that appears in a focus region of the captured digital image, and/or other types of selection criteria. Alternatively or in addition, a user of the dual-camera device 102 may provide a selection input, such as in a user interface displayed on the display screen of the device, and the imaging manager module 104 can select the object for extraction from the digital image based on receiving the user selection input that identifies the selected object 116.

At 408, the selected object is extracted from the digital image. For example, the imaging manager module 104 can be implemented with the image graphics application 220 that can extract the selected object 116 from the digital image 114. For a digital image 114 that is captured as a self-image of the user with the front facing camera 108, the extracted object 118 from the digital image 114 may be a depiction of the user.

At 410, a combined image is generated by superimposing the extracted object over the digital content as being captured by the rear facing camera. For example, the imaging manager module 104 implemented by the dual-camera device 102 can then generate the combined image 120 by superimposing the extracted object 118 over the digital content 110 as being captured by the rear facing camera 106 of the dual-camera device. The digital content 110 may be captured by the rear facing camera 106 as digital photos or digital video content of the camera scene 112, and the combined image 120 may be generated as the extracted object 118 superimposed over digital video content. For a digital image 114 that is captured as a self-image of the user with the front facing camera 108, the extracted object 118 from the digital image 114 may be a depiction of the user. In implementations, the imaging manager module 104 can include the image graphics application 220 that is designed to generate the combined image 120 by superimposing the depiction of the user over the digital content 110 as being captured by the rear facing camera 106 of the device. For the digital content 110 captured as a digital photo of an environment as viewable with the rear facing camera 106, the combined image 120 can be generated by superimposing the depiction of the user over the digital photo of the environment.

At 412, the extracted object is resized to appear proportional in scale as superimposed over the digital content that is captured by the rear facing camera. For example, the imaging manager module 104 implemented by the dual-camera device 102 can resize the extracted object 118 to appear proportional in scale as superimposed over the digital content 110 that is captured by the rear facing camera. In implementations, the imaging manager module 104 can receive a user input 308, 312 to resize the depiction of the user that is superimposed over the digital content 110, and as noted above, the imaging manager module 104 can include the image graphics application 220 that is designed to resize the extracted object 118 to appear proportional in scale as superimposed over the digital content 110 that is captured by the rear facing camera. Similarly, the imaging manager module 104 can receive a user input 304 to move the depiction of the user (e.g., the extracted object 118) that is superimposed over the digital content 110 as being captured by the rear facing camera 106 of the dual-camera device 102. Notably, the extracted object 118 may be moved in any direction and positioned over the digital content 110 at any location.

At 414, the combined image of the extracted object superimposed over the digital content is displayed. For example, the combined image 120 (e.g., as a digital photo, a video clip, real-time video, etc.) generated from the depiction of the user in the digital image 114 superimposed over the digital photo of the environment (e.g., the digital content 110) can be the displayed content on the display screen 236 of the dual-camera device 102, such as for viewing by the user of the device.

At 416, the combined image of the extracted object superimposed over the digital content is recorded. For example, the dual-camera device 102 can record, such as to memory 206, the combined image 120 of the extracted object 118 superimposed over the digital content. As noted above, the digital content 110 may be captured by the rear facing camera 106 as digital photos or digital video content of the camera scene 112. The combined image 120 may be generated as the extracted object 118 superimposed over digital video content, which can be recorded and maintained in memory of the dual-camera device.

At 418, the combined image of the extracted object superimposed over the digital content is communicated to an additional device. For example, the dual-camera device 102 can communicate the combined image 120 of the extracted object 118 superimposed over the digital content 110 to an additional device. In implementations, the dual-camera device 102 is a mobile phone that can establish communication with other communication-enabled devices, and the mobile phone communicates the combined image 120, or combined images in the form of digital video content, for viewing at other devices.

FIG. 5 illustrates various components of an example device 500, in which aspects of a combined image from front and rear facing cameras can be implemented. The example device 500 can be implemented as any of the devices described with reference to the previous FIGS. 1-4, such as any type of a mobile device, mobile phone, flip phone, client device, companion device, paired device, display device, tablet, computing, communication, entertainment, gaming, media playback, and/or any other type of computing and/or electronic device. For example, the dual-camera device 102 and the mobile device 202 described with reference to FIGS. 1 and 2 may be implemented as the example device 500.

The device 500 includes communication transceivers 502 that enable wired and/or wireless communication of device data 504 with other devices. The device data 504 can include any of the various devices and imaging manager module generated, determined, received, and/or stored data. Additionally, the device data 504 can include any type of audio, video, and/or image data. Example communication transceivers 502 include wireless personal area network (WPAN) radios compliant with various IEEE 802.15 (Bluetooth™) standards, wireless local area network (WLAN) radios compliant with any of the various IEEE 802.11 (WiFi™) standards, wireless wide area network (WWAN) radios for cellular phone communication, wireless metropolitan area network (WMAN) radios compliant with various IEEE 802.16 (WiMAX™) standards, and wired local area network (LAN) Ethernet transceivers for network data communication.

The device 500 may also include one or more data input ports 506 via which any type of data, media content, and/or inputs can be received, such as user-selectable inputs to the device, communications, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 500 includes a processor system 508 of one or more processors (e.g., any of microprocessors, controllers, and the like) and/or a processor and memory system implemented as a system-on-chip (SoC) that processes computer-executable instructions. The processor system may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits, which are generally identified at 510. The device 500 may further include any type of a system bus or other data and command transfer system that couples the various components within the device. A system bus can include any one or combination of different bus structures and architectures, as well as control and data lines.

The device 500 also includes memory and/or memory devices 512 (e.g., computer-readable storage memory) that enable data storage, such as data storage devices that can be accessed by a computing device, and that provide persistent storage of data and executable instructions (e.g., software applications, programs, functions, and the like). Examples of the memory devices 512 include volatile memory and non-volatile memory, fixed and removable media devices, and any suitable memory device or electronic data storage that maintains data for computing device access. The memory devices 512 can include various implementations of random access memory (RAM), read-only memory (ROM), flash memory, and other types of storage media in various memory device configurations. The device 500 may also include a mass storage media device.

The memory devices 512 (e.g., as computer-readable storage memory) provides data storage mechanisms to store the device data 504, other types of information and/or data, and various device applications 514 (e.g., software applications and/or modules). For example, an operating system 516 can be maintained as software instructions with a memory device and executed by the processor system 508. The device applications 514 may also include a device manager 518, such as any form of a control application, software application, signal-processing and control module, code that is specific to a particular device, a hardware abstraction layer for a particular device, and so on.

In this example, the device 500 includes an imaging manager module 520 that implements aspects of a combined image from front and rear facing cameras. The imaging manager module 520 may be implemented with hardware components and/or in software as one of the device applications 514, such as when the device 500 is implemented as the dual-camera device 102 described with reference to FIG. 1, or as the mobile device 202 described with reference to FIG. 2. Examples of the imaging manager module 520 includes the imaging manager module 104 that is implemented by the dual-camera device 102, and as described implemented by the mobile device 202, such as a software application and/or as hardware components in the dual-camera device and/or in the mobile device. In implementations, the imaging manager module 520 may include independent processing, memory, and logic components as a computing and/or electronic device integrated with the example device 500.

In this example, the device 500 also includes cameras 522 and motion sensors 524, such as may be implemented as components of an inertial measurement unit (IMU). The motion sensors 524 can be implemented with various sensors, such as a gyroscope, an accelerometer, and/or other types of motion sensors to sense motion of the device. The motion sensors 524 can generate sensor data vectors having three-dimensional parameters (e.g., rotational vectors in x, y, and z-axis coordinates) indicating location, position, acceleration, rotational speed, and/or orientation of the device. The device 500 can also include one or more power sources 526, such as when the device is implemented as a mobile device. The power sources may include a charging and/or power system, and can be implemented as a flexible strip battery, a rechargeable battery, a charged super-capacitor, and/or any other type of active or passive power source.

The device 500 can also include an audio and/or video processing system 528 that generates audio data for an audio system 530 and/or generates display data for a display system 532. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as via media data port 534. In implementations, the audio system and/or the display system are integrated components of the example device. Alternatively, the audio system and/or the display system are external, peripheral components to the example device.

Although implementations of a combined image from front and rear facing cameras have been described in language specific to features and/or methods, the subject of the appended claims is not necessarily limited to the specific features or methods described. Rather, the specific features and methods are disclosed as example implementations of a combined image from front and rear facing cameras, and other equivalent features and methods are intended to be within the scope of the appended claims. Further, various different examples are described and it is to be appreciated that each described example can be implemented independently or in connection with one or more other described examples. Additional aspects of the techniques, features, and/or methods discussed herein relate to one or more of the following:

A dual-camera device, comprising: a rear facing camera with a first imager to capture digital content of a camera scene as viewable with the rear facing camera; a front facing camera with a second imager to capture a digital image from a viewpoint opposite the rear facing camera, the digital image including depictions of one or more objects, the first and second imagers being operational together to capture the digital content and the digital image approximately simultaneously; an imaging manager module implemented at least partially in computer hardware to: select an object from the one or more objects depicted in the digital image for extraction from the digital image as an extracted object; and generate a combined image by superimposing the extracted object over the digital content as being captured by the rear facing camera.

Alternatively or in addition to the above described dual-camera device, any one or combination of: a display device to display the combined image of the extracted object superimposed over the digital content. The imaging manager module is implemented to initiate communication of the combined image of the extracted object superimposed over the digital content to an additional device. The digital content captured by the rear facing camera is digital video of the camera scene; and the imaging manager module is implemented to initiate recording the combined image of the extracted object superimposed over the digital video. The digital image is captured as a self-image with the front facing camera from a viewpoint facing a user of the dual-camera device; the extracted object from the digital image includes a depiction of the user; and the combined image is generated by superimposing the depiction of the user over the digital content as being captured by the rear facing camera. The digital content captured by the rear facing camera is a digital photo of an environment as viewable with the rear facing camera; the extracted object from the digital image includes a depiction of a user of the dual-camera device; and the combined image is generated by superimposing the depiction of the user over the digital photo of the environment. The imaging manager module is implemented to resize the extracted object to appear proportional in scale as superimposed over the digital content that is captured by the rear facing camera. The digital image is captured as a self-image with the front facing camera from a viewpoint facing a user of the dual-camera device; the extracted object from the digital image includes a depiction of the user; and the imaging manager module is implemented to receive a user input to resize the depiction of the user that is superimposed over the digital content as being captured by the rear facing camera.

A method, comprising: capturing digital content of a camera scene as viewable with a rear facing camera of a dual-camera device; capturing a digital image with a front facing camera from a viewpoint opposite of the rear facing camera, the digital image including depictions of one or more objects, the rear facing camera and the front facing camera being operational together to capture the digital content and the digital image approximately simultaneously; selecting an object from the one or more objects depicted in the digital image for extraction from the digital image as an extracted object; and generating a combined image by superimposing the extracted object over the digital content as being captured by the rear facing camera.

Alternatively or in addition to the above described method, any one or combination of: displaying the combined image of the extracted object superimposed over the digital content. The method further comprising communicating the combined image of the extracted object superimposed over the digital content to an additional device. The digital content captured by the rear facing camera is digital video of the camera scene, and the method further comprising recording the combined image of the extracted object superimposed over the digital video. The digital image is captured as a self-image with the front facing camera from a viewpoint facing a user of the dual-camera device; the extracted object from the digital image includes a depiction of the user; and the combined image is generated by superimposing the depiction of the user over the digital content as being captured by the rear facing camera. The digital content captured by the rear facing camera is a digital photo of an environment as viewable with the rear facing camera; the extracted object from the digital image includes a depiction of a user of the dual-camera device; and the combined image is generated by superimposing the depiction of the user over the digital photo of the environment. The method further comprising resizing the extracted object to appear proportional in scale as superimposed over the digital content that is captured by the rear facing camera. The digital image is captured as a self-image with the front facing camera from a viewpoint facing a user of the dual-camera device; the extracted object from the digital image includes a depiction of the user; and the method further comprising receiving a user input to resize the depiction of the user that is superimposed over the digital content as being captured by the rear facing camera.

A device, comprising: dual imagers operational together to capture digital content of a camera scene as viewable with a rear facing camera, and capture a digital image with a front facing camera, the digital image including depictions of one or more objects; a imaging manager module implemented at least partially in computer hardware to select an object from the one or more objects depicted in the digital image for extraction from the digital image; an image graphics application implemented at least partially in the computer hardware to: extract the selected object depicted in the digital image as an extracted object; and superimpose the extracted object over the digital content that is being captured by the rear facing camera in a combined image.

Alternatively or in addition to the above described device, any one or combination of: a display device to display the combined image of the extracted object superimposed over the digital content; and a communication interface to communicate the combined image of the extracted object superimposed over the digital content to an additional device. The device further comprising memory to maintain a recording of the combined image of the extracted object superimposed over the digital content. The digital image is captured as a self-image with the front facing camera from a viewpoint facing a user of the device; the extracted object from the digital image includes a depiction of the user; and the combined image is generated by superimposing the depiction of the user over the digital content as being captured by the rear facing camera.

1. A dual-camera device, comprising:
a rear facing camera with a first imager to capture video content of a camera scene as viewable with the rear facing camera;
a front facing camera with a second imager to capture digital images from a viewpoint opposite the rear facing camera, the digital images including depictions of one or more objects, the first and second imagers being operational together to capture the video content and the digital images approximately simultaneously;
an imaging manager module implemented at least partially in computer hardware to:
select an object from the one or more objects depicted in the digital images for extraction from the digital images as an extracted object;
generate combined video content by superimposing the extracted object over the video content as being captured by the rear facing camera; and
initiate communication of the combined video content as a real-time video chat with an additional device.

2. The dual-camera device as recited in claim 1, further comprising a display device to display the combined video content of the extracted object superimposed over the digital video.

3. The dual-camera device as recited in claim 1, wherein the combined video content of the extracted object superimposed over the digital video is updated during the real-time video chat with the additional device.

4. The dual-camera device as recited in claim 1, wherein:
the imaging manager module is implemented to initiate recording the combined video content of the extracted object superimposed over the digital video.

5. The dual-camera device as recited in claim 1, wherein:
the digital images are captured as a self-image with the front facing camera from a viewpoint facing a user of the dual-camera device;
the extracted object from the digital images includes a depiction of the user; and
the combined video content is generated by superimposing the depiction of the user over the digital video as being captured by the rear facing camera.

6. The dual-camera device as recited in claim 1, wherein:
the digital video captured by the rear facing camera is an environment as viewable with the rear facing camera;
the extracted object from the digital images includes a depiction of a user of the dual-camera device; and
the combined video content is generated by superimposing the depiction of the user over the digital video of the environment.

7. The dual-camera device as recited in claim 1, wherein the imaging manager module is implemented to resize the extracted object to appear proportional in scale as superimposed over the digital video that is captured by the rear facing camera.

8. The dual-camera device as recited in claim 1, wherein:
the digital images are captured as a self-image with the front facing camera from a viewpoint facing a user of the dual-camera device;
the extracted object from the digital images includes a depiction of the user; and
the imaging manager module is implemented to receive a user input to resize the depiction of the user that is superimposed over the digital video as being captured by the rear facing camera.

9. A method, comprising:
capturing digital video of a camera scene as viewable with a rear facing camera of a dual-camera device;
capturing digital images with a front facing camera from a viewpoint opposite of the rear facing camera, the digital images including depictions of one or more objects, the rear facing camera and the front facing camera being operational together to capture the digital video and the digital images approximately simultaneously;
selecting an object from the one or more objects depicted in the digital images for extraction from the digital images as an extracted object;
generating combined video content by superimposing the extracted object over the digital video as being captured by the rear facing camera; and
communicating the combined video content as a real-time video chat with an additional device.

10. The method as recited in claim 9, further comprising:
displaying the combined video content of the extracted object superimposed over the digital video.

11. The method as recited in claim 9, further comprising:
updating the combined video content of the extracted object superimposed over the digital video during the real-time video chat with the additional device.

12. The method as recited in claim 9, further comprising:
recording the combined video content of the extracted object superimposed over the digital video.

13. The method as recited in claim 9, wherein:
the digital images are captured as a self-image with the front facing camera from a viewpoint facing a user of the dual-camera device;
the extracted object from the digital images includes a depiction of the user; and
the combined video content is generated by superimposing the depiction of the user over the digital video as being captured by the rear facing camera.

14. The method as recited in claim 9, wherein:
the digital video captured by the rear facing camera is an environment as viewable with the rear facing camera;
the extracted object from the digital images includes a depiction of a user of the dual-camera device; and
the combined video content is generated by superimposing the depiction of the user over the digital video of the environment.

15. The method as recited in claim 9, further comprising:
resizing the extracted object to appear proportional in scale as superimposed over the digital video that is captured by the rear facing camera.

16. The method as recited in claim 9, wherein:
the digital images are captured as a self-image with the front facing camera from a viewpoint facing a user of the dual-camera device;
the extracted object from the digital images includes a depiction of the user; and
the method further comprising:
receiving a user input to resize the depiction of the user that is superimposed over the digital video as being captured by the rear facing camera.

17. A device, comprising:
dual imagers operational together to capture digital video of a camera scene as viewable with a rear facing camera, and capture digital images with a front facing camera, the digital images including depictions of one or more objects;
an imaging manager module implemented at least partially in computer hardware to select an object from the one or more objects depicted in the digital images for extraction from the digital images;
an image graphics application implemented at least partially in the computer hardware to:
extract the selected object depicted in the digital images as an extracted object; and
superimpose the extracted object over the digital video that is being captured by the rear facing camera in combined video content that is communicated as a real-time video chat with an additional device.

18. The device as recited in claim 17, further comprising:
a display device to display the combined video content of the extracted object superimposed over the digital video; and
a communication interface to communicate the combined video content of the extracted object superimposed over the digital video to the additional device.

19. The device as recited in claim 17, further comprising:
memory to maintain a recording of the combined video content of the extracted object superimposed over the digital video.

20. The device as recited in claim 17, wherein:
the digital images are captured as a self-image with the front facing camera from a viewpoint facing a user of the device;
the extracted object from the digital images includes a depiction of the user; and
the combined video content is generated by superimposing the depiction of the user over the digital video as being captured by the rear facing camera.
